(19) United States
(12) Patent Application Publication
(10) Pub. No.: US 2023/0340939 A1
(43) Pub. Date: Oct. 26, 2023

(54) VORTEX DYNAMIC POWER GENERATION STRUCTURE

(71) Applicant: CHEN-HSIN MEI, New Taipei City (TW)

(72) Inventor: CHEN-HSIN MEI, New Taipei City (TW)

(21) Appl. No.: 17/724,496

(22) Filed: Apr. 20, 2022

(51) Int. Cl. F03D 3/04; F03D 9/25; F03D 3/00; F03D 3/06

(52) U.S. Cl. CPC F03D 3/0409; F03D 9/25; F03D 3/005; F03D 3/061; F05B 2240/217; F05B 2240/30; F05B 2250/502; F05B 2250/501; F05B 2240/132

(57) ABSTRACT

The present invention provides a vortex dynamic power generation structure that consists of the cylindrical cavity, the driving mechanism and the power generating mechanism. The vertical cylindrical cavity has plural fluid inlets at side and the fluid outlet at the center of the top surface. The driving mechanism consists of the permeable blade set and the rotating axis is installed at the center of the cylindrical cavity. The character of present invention is as the following. The external fluid flows into the cylindrical cavity tangentially to form the vortex, and the vortex continue accelerates automatically as the tornado does. The vortex thrusts the driving mechanism to rotate, and the permeable blades allow the vortex maintain its spiral route. The permeable blades feedback rotating energy to further accelerate the vortex. The center part of the vortex flows along the axis of the cylindrical cavity to the outlet and exits. The power generating mechanism is connected to and driven by the driving mechanism to generate electricity.

### BACKGROUND OF THE INVENTION

### a) Field of the Invention

The present invention relates to a structure that employs vortex dynamic power to generate electricity, in particular to a device that applies the cylindrical cavity to create and accelerate the vortex, and applies the permeable blades to absorb the kinetic energy of the vortex to generate electricity.

### b) Description of the Prior Art

For large scale HAWTs, their problems are: vulnerable blades, high center of gravity, complicated structure, difficult to manufacture, transport, install, maintain, renew, demolish and recycle, danger to birds, noisy to people. In all, short lifecycle but high cost.

For VAWTs, they cannot suffer strong wind due to vulnerable axis and blades, so that their size is limited.

The present inventor has noted U.S. Pat. No. 4,452,562A which is obvious different from the present invention as follows:

For the U.S. Pat. No. 4,452,562A, “vertically disposed wind collecting tower with spaced apart inner and outer walls and a central bore. The upper end of the tower is open while the lower end of the structure is in communication with a wind intake chamber”. The inflow in the square wind intake chamber cannot form the vortex, will not accelerate automatically as the tornado does.

For the present invention, the cylindrical cavity is single wall in structure, the top surface is fully covered except to center part, and the bottom has no wind intake chamber to communication. The inflow pass through plural fluid inlets at the side wall of the cylindrical cavity and exits through the fluid outlet at the center of the top surface of the cylindrical cavity, thus forms the whole wind field in the cylindrical cavity and accelerates as a tornado.

For the U.S. Pat. No. 4,452,562A, the turbine with axis is installed between the wind collecting tower and the wind intake chamber. The blades of the turbine are not permeable. The airflow passes by the blade once only. The blades cannot feedback kinetic energy to further accelerate the air flow.

For the present invention, plural permeable blades with driving axis are installed inside of the cylindrical cavity as no wind intake chamber. After the inflow has crashed with the permeable blades, it can maintain spiral route and keep accelerating to intensity the vortex as a tornado does.

The present inventor have simulated the air field in the cylindrical cavity of present invention with CFD, which has proved, the vortex is formed in the cylindrical cavity, lower velocity at the brim of the vortex, much higher velocity at the center of the vortex, higher pressure at the brim of the vortex, much lower pressure at the center of the vortex, the center of the vortex flows toward the outlet. All of them are coincide with the characters of cyclone or tornado. Bases above, the present inventor has created the revolutionary device to solve all problems encountered on both HAWT and VAWT.

### SUMMARY OF THE INVENTION

The tornado contains high kinetic energy. The present invention applies the compact structure of cylindrical cavity to create a miniature tornado inside of it, and collects the kinetic energy of this tornado by permeable blades to produce electricity.

In order to fulfill the above requirements, the present invention has adopted following technical measures:

The present invention is a vortex dynamic power generation structure, which consists of the cylindrical cavity, the driving mechanism and the power generating mechanism. The driving mechanism is installed inside of the cylindrical cavity.

In the above-mentioned vortex dynamic power generation structure, the fluid flows into the cylindrical cavity and forms the vortex. The vortex thrusts the driving mechanism to rotate.

In the above-mentioned vortex dynamic power generation structure, the driving mechanism connects to and drives power generating mechanism.

In the above-mentioned vortex dynamic power generation structure, the cylindrical cavity has plural fluid inlet and single fluid outlet. The fluid inlets are opened on the side of the cylindrical cavity, and the fluid outlet is opened at the center of the top surface of the cylindrical cavity.

In the above-mentioned vortex dynamic power generation structure, each fluid inlet has at least one flow regulator to regulate the volume of the incoming flow.

In the above-mentioned vortex dynamic power generation structure, the external fluid flows into the cylindrical cavity tangentially through the fluid inlet. The inflow proceeds alongside the inner surface of the cylindrical cavity, then flows toward the center along a spiral route which forms the vortex. When the inflow approaches the center, it is pressed and turns toward the fluid outlet to exit.

In the above-mentioned vortex dynamic power generation structure, the driving mechanism consists of the rotating shaft which is installed at the center of the cylindrical cavity, and the blade set which is connected to the rotating shaft.

In the above-mentioned vortex dynamic power generation structure, the blade set has plural radially distributed brackets. The blades are permeable and attached to the brackets. The blades can be in net, grid, bar, or separated plane shape. The blades can also be attached to the rotating shaft directly.

In the above-mentioned vortex dynamic power generation structure, the inflow thrusts the blade sets, the blade sets drives the rotating shaft, and the rotating shaft drives the power generating mechanism to produce electricity.

In the above-mentioned vortex dynamic power generation structure, the cylindrical cavity has the heater inside to accelerate the flow.

In the above-mentioned vortex dynamic power generation structure, at least one end of the rotating shaft has a connecting part, which can be connected to the power generating mechanism. In case plural cylindrical cavities with plural driving mechanisms inside are stacked up, plural driving mechanisms \can be connected by connecting parts.

### BRIEF DESCRIPTION OF THE DRAWINGS

FIG. 1 is the schematic diagram of the external structure of the first embodiment of the present invention.

FIGS. 1a and 1b are the top view and the side view of the cylindrical cavity of the first embodiment of the present invention.

FIGS. 2a, 2b, 2c, 2d and 2e are the schematic diagrams of the driving mechanism with various blade shapes of the first embodiment of the present invention.

FIG. 3a is the schematic top view of the power generating mechanism according to the first embodiment of the present invention.

FIG. 3b is the schematic side view of the power generating mechanism of the first embodiment of the present invention.

FIG. 4a is the schematic top view of the fluid route in the cylindrical cavity of the first embodiment of the present invention.

FIG. 4b is the schematic side view of the fluid route in the cylindrical cavity of the first embodiment of the present invention.

FIG. 4c is the vector analysis diagram of the part A in the FIG. 4a of the first embodiment of the present invention.

FIG. 5a is the schematic top view of the fluid route in the cylindrical cavity of the second embodiment of the present invention.

FIG. 5b is the schematic side view of the fluid route in the cylindrical cavity of the second embodiment of the present invention.

FIG. 6 is the schematic diagram of plural cylindrical cavities with driving mechanisms inside stacked up on power generating mechanism to constitute the vortex dynamic power generation structure which is the third embodiment of the present invention.

FIG. 7 is the first embodiment of the present invention with external baffles to increase the volume, pressure and speed of the inflow.

### DETAILED DESCRIPTION OF THE PREFERRED EMBODIMENTS

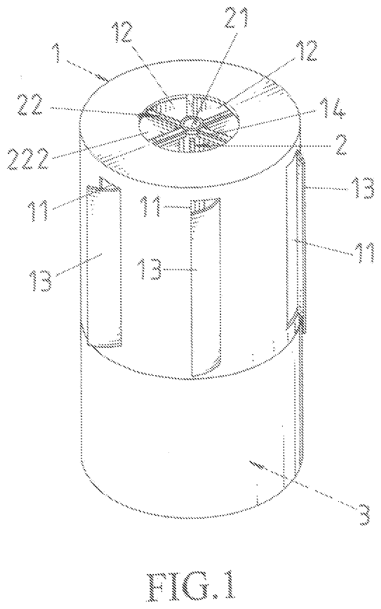

Please refer to FIGS. 1 to 6, which are the schematic diagrams of various embodiments of the present invention. As shown in these figures, the present invention is a vortex dynamic power generation structure which consists of the cylindrical cavity 1, the driving mechanism 2 and the power generating mechanism 3.

As shown in FIG. 1, the cylindrical cavity 1 has plural fluid inlet 11 at the side surface and single fluid outlet 12 at the center of the top surface. The external fluid flows into the cylindrical cavity 1 tangentially through the fluid inlet 11, and exits through the fluid outlet 12. As shown in FIGS. 1a and 1b, the fluid inlet 11 has the flow regulator 13. The flow regulators 13 control the opening and closing of the fluid inlets 11 to regulate the volume, pressure and speed of the inflow 41.

As shown in FIG. 1, the driving mechanism 2 is installed inside of the cylindrical cavity 1.

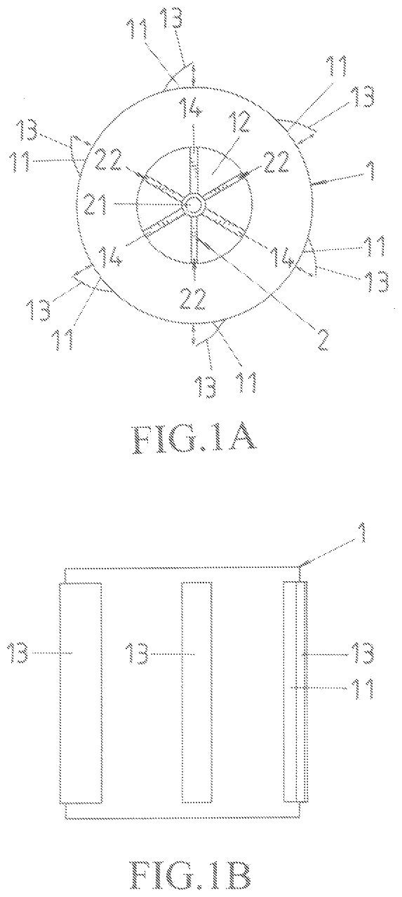

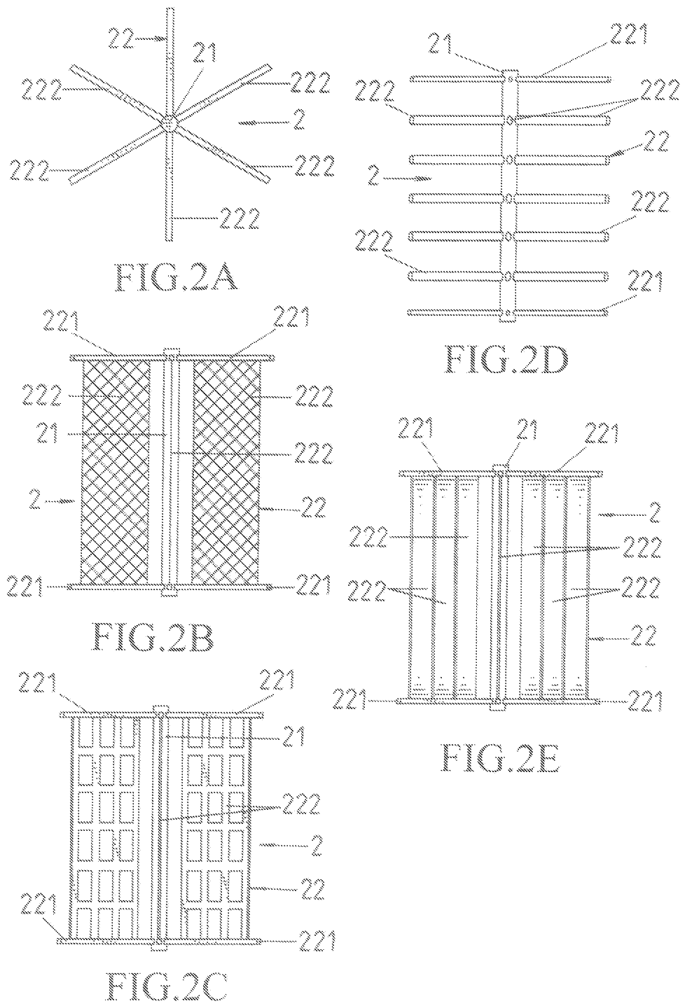

As shown in FIG. 2a, in the first embodiment of the present invention, the driving mechanism 2 consists of the rotating shaft 21 and the blade set 22. The rotating shaft 21 locates at the center of the cylindrical cavity 1, and the blade set 22 is connected to the rotating shaft 21. To thrust the blade set 22 can drive the rotating shaft 21, and the driving mechanism 2 can generate kinetic energy accordingly.

As shown in FIG. 2b, in the first embodiment of the present invention, the blade set 22 consists of the radially distributed brackets 221 and plural permeable blades 222. The brackets 221 are connected to the rotating shaft 21, and the permeable blades 222 are attached to the brackets 221 or directly attached to the rotating shaft 21 (as shown in FIG. 2d). The permeable blades 222 can be mesh shape (as shown in FIG. 2b), grid shape (as shown in FIG. 2c), bar shape (as shown in FIG. 2d) or separated plane shape (as shown in FIG. 2e). The blade 222 is permeable, so that the inflow 41 can pass through, maintain its spiral route 51 and accelerates. The blade 222 can feedback its kinetic energy to accelerate the vortex.

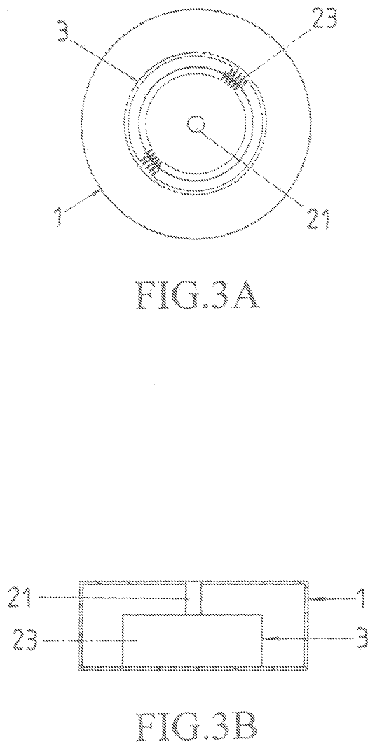

As shown in FIGS. 3a and 3b, in the first embodiment of the present invention, the cylindrical cavity 1 has the heater 23 inside to accelerate the fluid. All kinds of heating sources including wasted heat can be applied.

As shown in FIG. 3b, the power generating mechanism 3 is connected to and driven by the driving mechanism 2, so that the electric generator 31 in the power generating mechanism 3 can generate electricity.

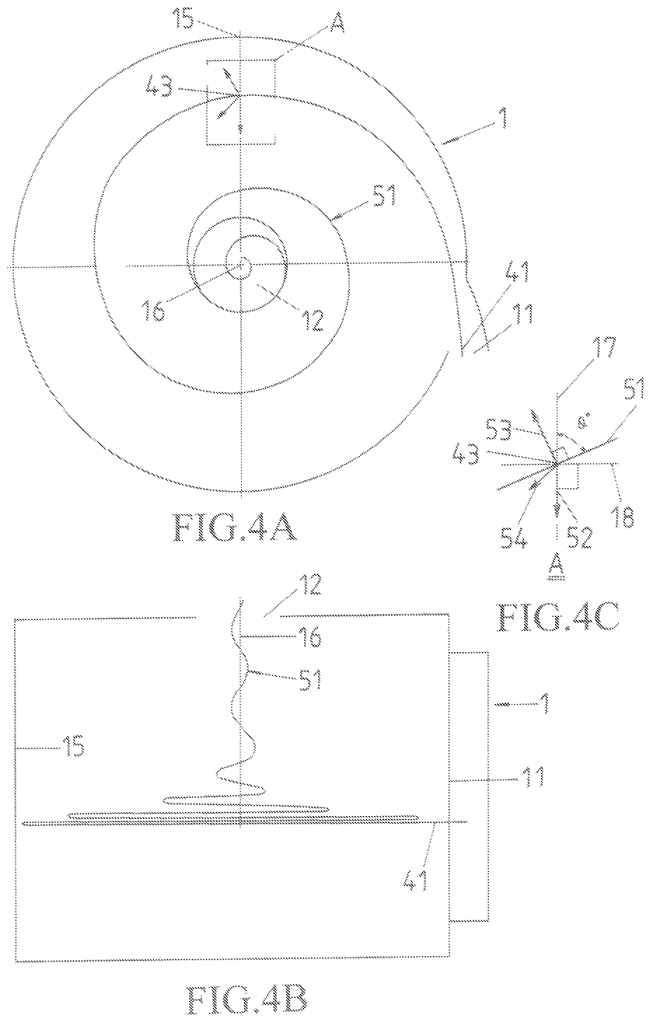

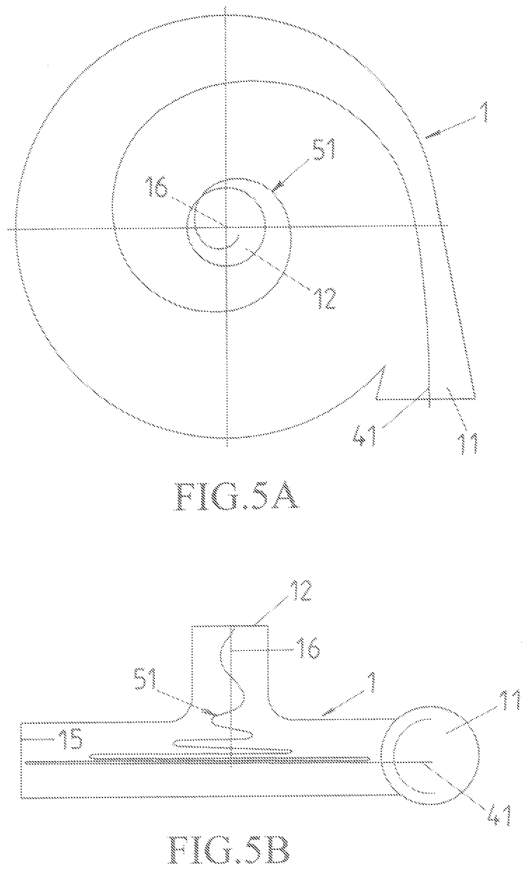

As shown in FIGS. 4a and 4c, the present invention guides the external fluid (such as wind) to flow tangentially into the cylindrical cavity 1. The inflow 41 proceeds alongside the inner surface of the cavity 15 due to persistent pressure behind, then proceeds along the spiral route 51 until approaching the axis 16, and finally turns toward the outlet 12. The flow field from the fluid inlet 11 to the fluid outlet 12 is thus formed, The pressure at the fluid inlet 11 and alongside the inner surface of the cavity 15 are the highest, The direction of outflow 42 is certainly perpendicular to the atmosphere wind direction, so the pressure at fluid outlet 12 is the lowest (Bernoulli's effect). The pressure dwindles from the inner surface of cavity 15 to the axis 16 while the velocity escalates from the inner surface of cavity 15 to the axis 16. The cylindrical cavity 1 has created an accelerative flow field inside, similar to a tornado.

As shown in FIGS. 4a and 4c, the pressure dwindles from the inner surface of the cavity 15 to the axis 16. The fluid molecule 43 proceeds along the spiral route 51 suffers the pressure gradient force 52 that toward the axis 16 and the Coriolis force 53 that perpendicular to the spiral route 51. The above two forces generate the combined vector force 54 which increases the velocity “v” of the fluid molecule 43. Meanwhile, the turning radius of the fluid molecule 43 dwindles along the spiral route 51 which causes angular velocity “ω” to escalate. According to the formula that Coriolis force F=−2m(ωv), F, ω and v increase simultaneously due to interactive feedback. The unique structure of the cylindrical cavity 1 accelerates the inflow 41 automatically.

As shown in FIGS. 5a and 5b, the second embodiment of the present invention is the structure that automatically accelerate the inflow 41 in the cylindrical cavity 1. The inlet 11 is funnel shaped to accept more inflow 41.

As shown in FIGS. 4a, the inflow 41 accelerates along the spiral route 51 and rotates the blade set 22 (As shown in FIG. 2a). The inner part of the blade set 22 suffers more thrust than the outer part, the blade set 22 will be further thrust and accelerates the inflow 41, which causes interactive feedback between the inflow 41 and the blade set 22.

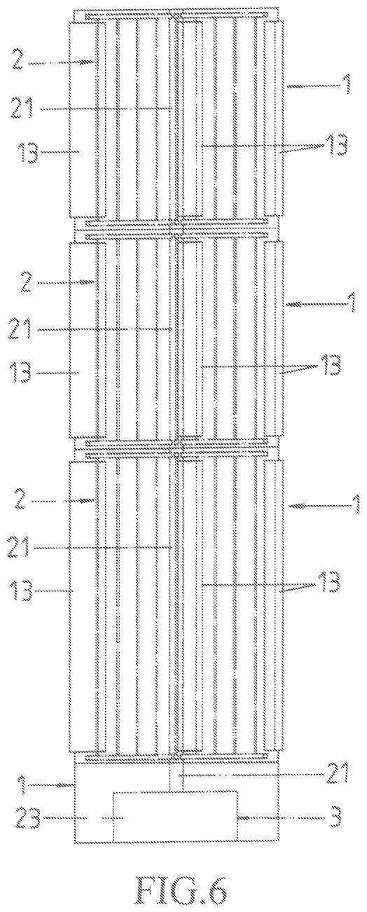

Please refer to FIG. 6, in the third embodiment of the present invention, at least one end of the rotating shaft 21 of the driving mechanism 2 to be provided with a connecting portion (not shown in the figure). In case stacking plural cylindrical cavities 1 to constitute the vortex dynamic power generation structure, plural driving mechanisms 2 in plural cylindrical cavities 1 can be connected, and the power generating mechanism 3 is connected to the terminal driving mechanism 2. The center of end surfaces between plural cylindrical cavities are opened for fluid to pass through. The power generating mechanism 3 can be the combination of several electric generators to match various wind scale.

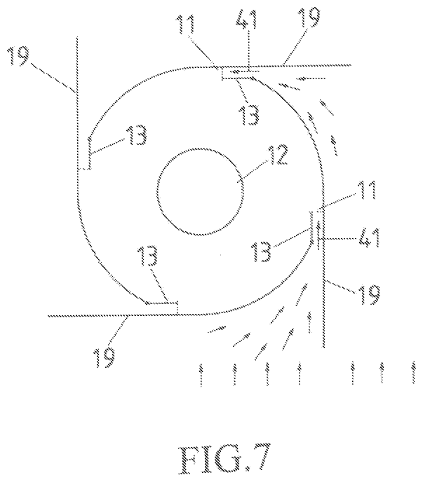

Please refer to FIG. 7, in the first embodiment of the present invention. The baffles 19 are installed out of the fluid inlets 11 to increase the volume and velocity of the inflow.

In the first embodiment of the present invention, the cylindrical cavity 1 can be installed in the river or the sea current and apply water as inflow 41. The power generating mechanism 3 to be installed on the top of the cylindrical cavity 1, the fluid outlet 12 to be at the bottom with drainpipe toward downstream. The flow speed at inner surface of the cavity 15 is slower which causes higher pressure. The Coriolis force 53 of the inflow 41 together with the pressure gradient force 52 generate the combined vector force 54, which accelerates the inflow 41 to flow toward the axis 16 then turns downward to fluid outlet 12. The inflow 41 thrusts the blade set 22 and rotates the rotating shaft 21, which drives the rotating shaft 21 of the power generating mechanism 3 to generate electricity.

In summary, the present invention of vortex dynamic power generation structure, plural fluid inlets are opened at the vertical side of the cylindrical cavity, the fluid outlet is opened at the center of the end surface of the cylindrical cavity. The external fluid enters the cylindrical cavity tangentially through the inlet and exits through the outlet at the top surface. The driving mechanism which is inside of the cylindrical cavity consists of the rotating shaft and the permeable blade set. The inflow thrusts the plural permeable blade set and rotating shaft to turn. By applying plural permeable blades, the inflow can maintain spiral route and accelerate, also to drive the power generating mechanism to generate electricity.

1. A vortex dynamic power generation structure, which consists of:
a cylindrical cavity, which has plural fluid inlet at the vertical side and a fluid outlet at the center of the top surface of the cylindrical cavity. The external fluid flows into the cylindrical cavity tangentially through the fluid inlet, proceeds alongside the inner surface of the cylindrical cavity, then flows toward the axis along the spiral route until it finally turns toward the outlet to exit, which creates the wind field similar to a tornado within the cylindrical cavity;
a driving mechanism, which is installed inside of the cylindrical cavity. The driving mechanism consists of the rotating shaft and the blade set. The rotating shaft locates at the axis of the cylindrical cavity, and the blade set consists of the brackets and plural permeable blades. The blade set is connected to the rotating shaft, so that the inflow thrusts the blade set and drives the rotating shaft. The inflow can maintain spiral route and keep accelerating even after crashing with plural permeable blades. The blades can feedback their rotating power to further accelerate the vortex.
a power generating mechanism, which is connected to and driven by the driving mechanism to generate electricity.

2. The vortex dynamic power generation structure according to claim 1, the external fluid-flows tangentially into the cylindrical cavity, then flows toward the axis along the spiral route, and finally turns toward the outlet, which becomes the automatic fluid accelerating structure.

3. The vortex dynamic power generation structure according to claim 1, the fluid inlets have the flow regulator which controls the volume of the inflow.

4. The vortex dynamic power generation structure according to claim 1, the power generating mechanism is connected to either end of the driving-mechanism, and installed at inside or outside of the cylindrical cavity.

5. The vortex dynamic power generation structure according to claim 1, the heater is-provided inside of the cylindrical cavity.

6. The vortex dynamic power generation structure according to claim 1, the blade set has-plural radially distributed brackets with plural permeable blades. The brackets are connected to the rotating shaft, and the blades are attached to the brackets or directly attached to the rotating shaft.

7. The vortex dynamic power generation structure according to claim 1, the permeable-blades are in mesh, grid, bar, or separated plane shape.

8. The vortex dynamic power generation structure according to claim 1, at least one end of the rotating shaft is provided with a connecting portion. In case plural cylindrical cavities with plural driving mechanisms inside are stacked-up, the center of end surfaces between the cylindrical cavities are opened for fluid to pass through, and all of the rotating shafts can be connected by the connecting portion.

9. The vortex dynamic power generation structure according to claim 1, baffles are installed-out of the fluid inlets to increase the volume, pressure and speed of the inflow.

10. The vortex dynamic power generation structure according to claim 1, the power-generating mechanism consists of plural electric generators in combination to match various wind scale.
